(19) United States
(12) Patent Application Publication
(10) Pub. No.: US 2023/0142638 A1
(43) Pub. Date: May 11, 2023

(54) ELECTRIC CONNECTION BOX

(71) Applicants: Sumitomo Wiring Systems, Ltd., Yokkaichi (JP); Toyota Jidosha Kabushiki Kaisha, Toyota-shi (JP)

(72) Inventors: Asuka MORI, Yokkaichi (JP); Yoshiki Yanagita, Nagakute-shi (JP); Shogo Tomihira, Nisshin-shi (JP)

(21) Appl. No.: 18/054,700

(22) Filed: Nov. 11, 2022

(30) Foreign Application Priority Data
Nov. 11, 2021 (JP) 2021-184099

(51) Int. Cl. H02G 3/08; H02G 3/16; F16C 11/04; B60R 16/023

(52) U.S. Cl. CPC H02G 3/081; B60R 16/0238; F16C 11/04; H02G 3/16

(57) ABSTRACT

Provided is an electric connection box with which the workability of assembly work can be enhanced and the occurrence of problems attributable to forgetting to close a cover can be prevented. A vehicular electric connection box includes: a housing having a connecting portion including a terminal connected to an external bus bar; and a cover member opening and closing the connecting portion, in which the cover member has a lid portion exposing or shielding the terminal with the cover member closed.

This Non-provisional application claims priority of Japanese Patent Application No. 2021-184099 filed on November, 11, 2021, the contents of which are incorporated herein.

### TECHNICAL FIELD

The present disclosure relates to a vehicular electric connection box provided with a bus bar.

### BACKGROUND

In the related art, a vehicle is equipped with an electric connection box having a circuit using a bus bar so that a relatively large current is conducted. In addition, nowadays, the values of currents flowing through bus bars are also increasing along with vehicular functional expansion.

Japanese Patent Laid-Open Publication No. 2020-181908 discloses an electric connection box in which a housing with an openable and closable lid portion is provided, a bus bar can be attached to the inside of the housing by opening the lid portion, and the lid portion can be closed after the bus bar attachment.

In many electric connection boxes, a terminal is exposed to the outside via a through hole penetrating a housing, and a bus bar or the like can be connected to the terminal from the outside of the housing.

In addition, a cover covering the terminal is provided so that the occurrence of problems attributable to terminal exposure is suppressed.

Meanwhile, when a worker intends to perform the assembly work of connecting a bus bar to the terminal with the cover closed, the cover needs to be opened prior to such assembly work, which is troublesome.

In addition, in a case where the bus bar needs to be removed from the terminal for some reason, the worker opens the cover to perform the removal work and may forget to close the cover after the removal work. In this case, the terminal remains exposed to the outside, which may result in electric shock, electric leakage, short circuit, and the like.

However, as for the electric equipment according to Japanese Patent Laid-Open Publication No. 2020-181908, nothing is considered as to a case where a terminal is exposed via a through hole in a housing, nothing is considered as to such problems, and such problems cannot be solved.

### SUMMARY

The present disclosure has been made in view of such circumstances, and an object of the present disclosure is to provide an electric connection box with which the workability of assembly work can be enhanced and the occurrence of problems attributable to forgetting to close a cover can be prevented.

A vehicular electric connection box according to an embodiment of the present disclosure includes: a housing having a connecting portion including a terminal connected to an external conductive tool; and a cover member opening and closing the connecting portion, in which the cover member has a lid portion exposing or shielding the terminal with the cover member closed.

Provided according to the present disclosure is an electric connection box with which the workability of assembly work can be enhanced and the occurrence of problems attributable to forgetting to close a cover can be prevented.

### BRIEF DESCRIPTION OF THE DRAWINGS

FIG. 1 is a perspective view of an electric connection box according to the present embodiment;

FIG. 2 is an enlarged view illustrating a connecting portion and the vicinity of the connecting portion in the electric connection box of the present embodiment;

FIG. 3 is a diagram exemplifying a state where a cover member covers the connecting portion in the electric connection box of the present embodiment;

FIG. 4 is side, front, and bottom views of the cover member of the electric connection box of the present embodiment;

FIG. 5A is a plan view illustrating a state where the cover member is fully open in the electric connection box of the present embodiment;

FIG. 5B is a cross-sectional view of FIG. 5A taken along line B-B of FIG. 5A;

FIG. 6 is a diagram illustrating a case where the cover member is closed in the electric connection box of the present embodiment;

FIG. 7A is a longitudinal sectional view of FIG. 6 taken along line VIIA-VIIA of FIG. 6;

FIG. 7B is a longitudinal sectional view of FIG. 6 taken along line VIIB-VIIB of FIG. 6; and

FIG. 8 is a diagram illustrating a case where only a lid portion is open when the cover member is closed in the electric connection box of the present embodiment.

### DETAILED DESCRIPTION OF PREFERRED EMBODIMENTS

First, an aspect of implementation of the present disclosure will be listed and described. In addition, at least a part of the embodiment described below may be combined in any manner.

### First Aspect

A vehicular electric connection box according to a first aspect of the present disclosure includes: a housing having a connecting portion including a terminal connected to an external conductive tool; and a cover member opening and closing the connecting portion, in which the cover member has a lid portion exposing or shielding the terminal with the cover member closed.

In the first aspect, the cover member has the lid portion and, even with the cover member closed, the lid portion is capable of exposing or shielding the terminal. Accordingly, in, for example, connecting or removing an external conductive tool to or from the terminal, the cover member does not have to be opened, only the lid portion needs to be opened, and thus workability can be enhanced.

### Second Aspect

In the electric connection box according to a second aspect of the present disclosure, the cover member is provided with a hinge holding the lid portion, and the hinge biases the lid portion so as to shield the terminal.

In the second aspect, the hinge biases the lid portion so as to shield the terminal. Even in a case where, for example, a worker forgets to close the lid portion after connecting or removing an external conductive tool to or from the terminal, the restoring force of the hinge generated when the hinge bends acts as a force to bias the lid portion such that the terminal is shielded, and thus the lid portion covers the terminal and the terminal can be prevented from being exposed.

### Third Aspect

In the electric connection box according to a third aspect of the present disclosure, the hinge has a rectangular plate shape and is connected to the lid portion on a side of one long side, and a groove is formed in one main surface of the hinge and a thickness of the hinge decreases toward a middle portion in a width direction.

In the third aspect, the hinge has a rectangular plate shape, the groove is formed in one main surface, and the thickness of the hinge decreases toward the middle portion in the width direction. Accordingly, it is easy to open the lid portion in order to reach the open state and, when the lid portion is in the open state, the restoring force biasing the lid portion such that the terminal is shielded is generated at the hinge.

### Fourth Aspect

In the electric connection box according to a fourth aspect of the present disclosure, the hinge is two in number and the two hinges are arranged side by side in a length direction at an interval.

In the fourth aspect, the lid portion is held by the two hinges. Even in a case where one of the hinges is broken, the other hinge continues to hold the lid portion, and thus problems can be prevented from occurring.

### Fifth Aspect

The electric connection box according to a fifth aspect of the present disclosure further includes an opening maintaining mechanism maintaining an open state of the cover member.

In the fifth aspect, the open state of the cover member is maintained by the opening maintaining mechanism. For example, such an electric connection box can be transported with the cover member remaining open for convenience in assembly work.

### Sixth Aspect

In the electric connection box according to a sixth aspect of the present disclosure, the opening maintaining mechanism includes: a notch formed in a holding portion holding the hinge from a vicinity of the other long side of the hinge; and an opening maintaining portion provided in the housing to engage with the notch and maintain the open state in a case where the cover member is in the open state.

In the sixth aspect, in a case where the cover member is open, the notch formed in the holding portion holding the hinge and the opening maintaining portion provided in the housing are engaged to maintain the open state of the cover member. Accordingly, such an electric connection box can be transported with the cover member remaining open for convenience in assembly work.

An electric connection box according to an embodiment of the present disclosure will be described below with reference to the drawings. It should be noted that the present disclosure is not limited to the exemplifications. The present disclosure is defined by the scope of the claims and is intended to include every modification within the meaning and scope equivalent to the scope of the claims.

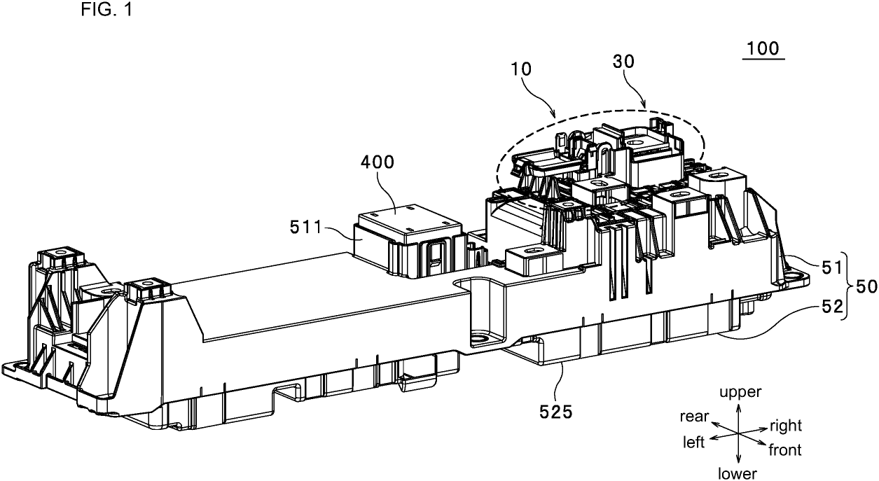

FIG. 1 is a perspective view of an electric connection box 100 according to the present embodiment. The electric connection box 100 is a so-called vehicular junction box where various electronic components are mounted.

In the present embodiment, for convenience, the “front”, “rear”, “left”, “right”, “upper”, and “lower” sides of the electric connection box 100 are defined by the front-rear, left-right, and up-down directions illustrated in the drawings. The front-rear, left-right, and up-down directions defined in this manner will be used in the following description.

The electric connection box 100 is attached to the outside of, for example, an electric vehicle (EV) battery pack. The electric connection box 100 includes a housing 50 where an electrical component such as a relay 400 is mounted.

The housing 50 is made of, for example, resin or metal and extends in the left-right direction. The housing 50 includes a lower case 52 close to the battery pack and an upper case 51 covering the lower case 52. The housing 50 is attached to the battery pack with, for example, a bottom plate 525 of the lower case 52 in contact with the battery pack.

The outside surface of the ceiling plate of the upper case 51 is provided with one mounting portion 511 for mounting the relay 400 and a connecting portion 30 where connection to an external bus bar, a connector, or the like (conductive tool) is performed. In addition, a cover member 10 opening and closing the connecting portion 30 is rotatably provided on the upper case 51.

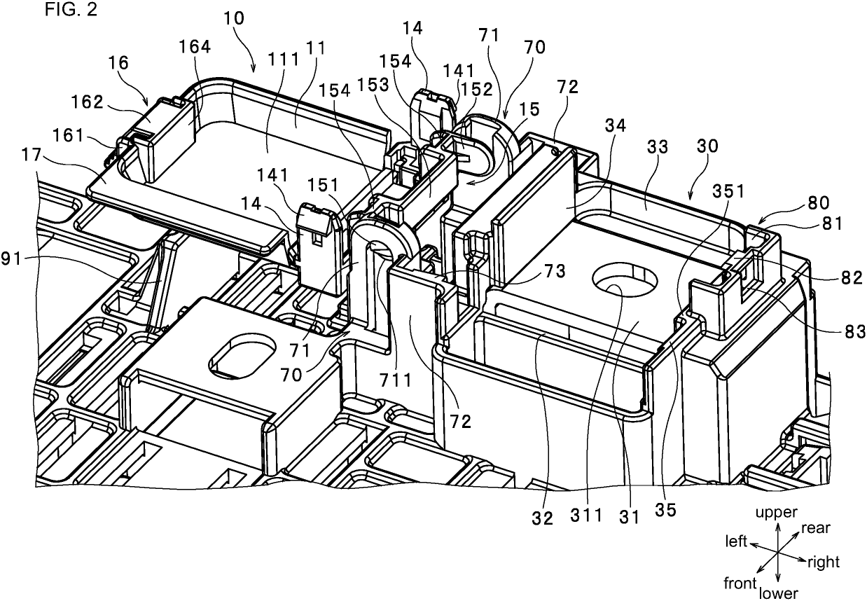

FIG. 2 is an enlarged view illustrating the connecting portion 30 and the vicinity of the connecting portion 30 in the electric connection box 100 of the present embodiment. FIG. 2 illustrates the dashed-line part in FIG. 1 in an enlarged manner and illustrates a state where the connecting portion 30 is open. The cover member 10 is rotatably held by a support mechanism 70 and covers or opens the connecting portion 30 by rotating.

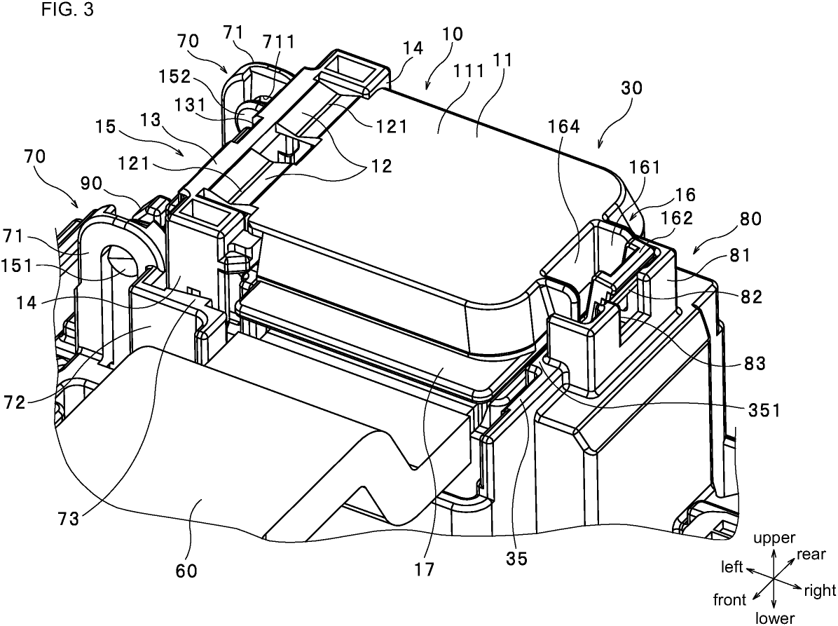

FIG. 3 is a diagram exemplifying a state where the cover member 10 covers the connecting portion 30 in the electric connection box 100 of the present embodiment. For convenience, FIG. 3 illustrates a state where an external bus bar 60 is connected to the connecting portion 30. The cover member 10 covers the entire connecting portion 30 including the connecting part of the bus bar 60 connected to the connecting portion 30.

In the electric connection box 100, in a case where the cover member 10 covers the connecting portion 30, a closing maintaining portion 14 (described later) and an engaged portion 72 (described later) are engaged with each other and such a state is maintained. In addition, the electric connection box 100 has an opening maintaining mechanism for maintaining a state where the cover member 10 does not cover the connecting portion 30 and the connecting portion 30 is open. The opening maintaining mechanism will be described in detail later.

Hereinafter, a state where the cover member 10 covers the connecting portion 30 or a state where the closing maintaining portion 14 and the engaged portion 72 are engaged will be referred to as the closed state of the cover member 10 and a state where the closing maintaining portion 14 and the engaged portion 72 are not engaged and the cover member 10 does not cover the connecting portion 30 will be referred to as the open state of the cover member 10. Whether the cover member 10 is in the closed state or the open state is irrelevant to whether a lid portion 11 (described later) is closed or open.

The cover member 10 has the lid portion 11 that can be opened and closed in the closed state of the cover member 10, and the lid portion 11 exposes or shields a terminal 31 (described later) of the connecting portion 30. Hereinafter, a state where the terminal 31 of the connecting portion 30 is exposed to the outside will be referred to as the open state of the lid portion 11 and a state where the terminal 31 is shielded by the lid portion 11 will be referred to as the closed state of the lid portion 11. The cover member 10 is provided with a lock portion 16 for maintaining the closed state of the lid portion 11. An engaging portion 80 engaging with the lock portion 16 is provided in the vicinity of the connecting portion 30.

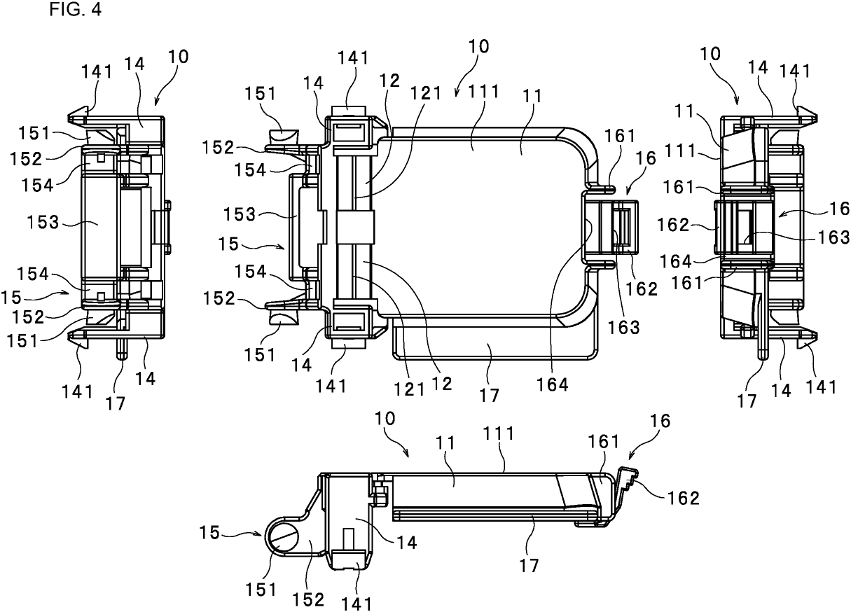

FIG. 4 is side, front, and bottom views of the cover member 10 of the electric connection box 100 of the present embodiment. Of the four drawings in FIG. 4, that in the middle is the front view, that to the left of the front view is the left side view, that to the right of the front view is the right side view, and that below the front view is the bottom view.

The lid portion 11 has a substantially rectangular flat plate 111 and side walls rising obliquely outward from the respective edges of the flat plate 111 except for one short side and is substantially dish-shaped. A flange portion 17 extends in parallel with the flat plate 111 at the tip of the side wall that is related to the long side on the front side among the side walls of the lid portion 11. The flange portion 17 is substantially strip-shaped.

Two hinges 12 holding the lid portion 11 are continuously provided on the one short side of the flat plate 111. The two hinges 12 have the same shape and are provided on the one short side of the flat plate 111 at a predetermined interval. Each hinge 12 has a rectangular plate shape and one long side is connected to the flat plate 111. In other words, the two hinges 12 are arranged side by side in the length direction at a predetermined interval. The hinge 12 is configured from an elastic material such as resin.

In addition, in each hinge 12, a groove 121 is formed in one of both main surfaces that faces upward in the closed state of the lid portion 11. The groove 121 is V-shaped in a longitudinal sectional view (see FIG. 3). In other words, the thickness of each hinge 12 decreases toward the middle portion in the width direction.

The other long side of each hinge 12 is connected to a holding portion 13 extending in the front-rear direction. In other words, the holding portion 13 holds the two hinges 12 from the vicinity of the other long sides of the two hinges 12. The holding portion 13 has a square rod shape with a length substantially equal to the width of the flat plate 111 and is connected to a rotating shaft portion 15 rotating the cover member 10. A rectangular notch 131 is formed in the middle portion on the front-rear direction in the holding portion 13 (see FIG. 3). In the holding portion 13, the notch 131 is formed on the side opposite to the hinge 12.

The lid portion 11 is held by the hinge 12 in this manner, and thus the lid portion 11 can be opened and closed in the closed state of the cover member 10. In addition, the groove 121 is provided in one main surface of the upper side of the hinge 12, and thus the hinge 12 can bend such that the lid portion 11 is opened and the terminal 31 of the connecting portion 30 is exposed. In addition, in a case where the hinge 12 is bent, that is, in a case where the lid portion 11 is in the open state, the restoring force of the hinge 12 acts as a force to close the lid portion 11. In other words, in a case where the lid portion 11 is open and the terminal 31 of the connecting portion 30 is exposed, the hinge 12 biases the lid portion 11 such that the terminal 31 is shielded.

In the lid portion 11, the lock portion 16 is provided on the other short side facing the one short side of the flat plate 111. The lock portion 16 is provided in the middle portion of the side wall related to the other short side. The lock portion 16 has a rectangular plate portion 164 vertically extending from the other short side of the flat plate 111 and a pair of facing plate portions 161 extending from both ends of the rectangular plate portion 164 to the outside of the lid portion 11. An engaging knob 162 is provided between the pair of facing plate portions 161. The engaging knob 162 is made of an elastic and rectangular plate material, one end portion thereof is bent and continuously provided at the tip of the rectangular plate portion 164, and a stepped step is formed in the other end portion thereof. A rectangular engaging hole 163 engaging with an engaging protrusion 82 (described later) of the engaging portion 80 is formed in the middle portion of the engaging knob 162.

Between the holding portion 13 and the lid portion 11 (flat plate 111) and outside the two hinges 12 in the front-rear direction, the closing maintaining portions 14 for maintaining the closed state of the cover member 10 are respectively provided. The closing maintaining portion 14 has a square tube shape. The closing maintaining portion 14 is long in the up-down direction when the cover member 10 is in the closed state (see FIGS. 2 and 3). As for each of the closing maintaining portions 14, of the two side walls facing each other in the front-rear direction, the outer side wall is longer than the other side wall. A tapered engaging hook 141 is formed on the outside surface of an end portion of such an outer side wall.

As described above, the holding portion 13 holding the hinge 12 is connected to the rotating shaft portion 15 rotating the cover member 10.

The rotating shaft portion 15 has a connection portion 153 connected to the holding portion 13. The connection portion 153 is made of a substantially band-shaped plate material and extends in the front-rear direction. The connection portion 153 is bent toward the lid portion 11 while being widened in both end portions and is connected to the holding portion 13 in both end portions (see FIG. 4).

A pair of holding brackets 152 for holding rotating shafts 151 (described later) are provided on both end sides of the connection portion 153, namely in both end portions of the holding portion 13. Each holding bracket 152 has a substantially L-shaped plate shape, and the two holding brackets 152 are disposed so as to face each other in the front-rear direction. The holding brackets 152 are respectively connected to both end portions of the holding portion 13, and each holding bracket 152 is provided with the rotating shaft 151.

The rotating shafts 151 protrude on the surfaces on the sides opposite to the facing surfaces of the holding brackets 152. The rotating shaft 151 has a columnar shape and has a tip portion obliquely notched in the circumferential direction. Horizontal portions 154 are provided between the respective holding brackets 152 and both end portions of the connection portion 153, and the holding brackets 152 and both end portions of the connection portion 153 are connected via the horizontal portions 154.

The rotating shaft 151 of the cover member 10 is rotatably held by the support mechanism 70. The support mechanism 70 has a pair of fitting plates 71 with which the rotating shafts 151 are fitted. The pair of fitting plates 71 are provided in the vicinity of the connecting portion 30 on the left side of the connecting portion 30 (see FIGS. 2 and 3). Each fitting plate 71 has a rectangular plate shape and extends in the up-down direction. The two fitting plates 71 are disposed so as to face each other in the front-rear direction. The tip of each fitting plate 71 is chamfered, a notch is formed in the upper end portion of the surface of one fitting plate 71 that faces the other fitting plate 71, and a recess that is long in the up-down direction is formed also in the surface on the side opposite to the facing surface. In addition, as for each fitting plate 71, a circular through hole 711 penetrating the fitting plate 71 in the thickness direction is formed in the bottom of the upper end portion of the recess. The rotating shafts 151 of the cover member 10 are respectively fitted in the through holes 711.

On the right long side portions of the respective fitting plates 71, the engaged portions 72 engaging with the closing maintaining portions 14 of the cover member 10 to maintain the closed state of the cover member 10 are provided respectively and continuously. Each engaged portion 72 has a rectangular plate shape and is provided between the fitting plate 71 and the connecting portion 30. Each engaged portion 72 is provided in front of or behind the fitting plate 71, and the left end portion thereof is bent toward the fitting plate 71. The two engaged portions 72 face each other in the front-rear direction. An engaged protrusion 73 engaging with the engaging hook 141 of the closing maintaining portion 14 protrudes from the inside surface of each engaged portion 72 (see FIGS. 2 and 3).

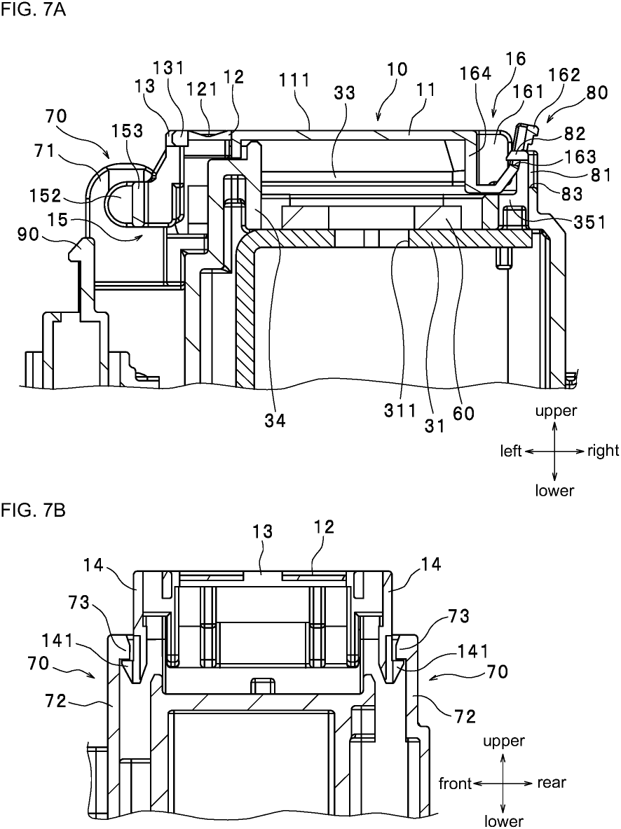

The connecting portion 30, which is opened and closed by the cover member 10, has a rectangular exposure hole 32 exposing the terminal 31, which is one end portion of the bus bar mounted in the housing 50. The exposure hole 32 is surrounded by side walls 33, 34, and 35 except for one side on the front side. The side wall 34 is erected on the left side of the exposure hole 32, the side wall 33 is erected on the rear side of the exposure hole 32, and the side wall 35 is erected on the right side of the exposure hole 32. The side wall 34 is higher than the side walls 33 and 35 in the up-down direction. In a case where the lid portion 11 (cover member 10) is in the closed state, the upper end of the side wall 35 abuts against the flat plate 111 (see FIG. 7A). In addition, the middle portion of the side wall 35 is provided with an abutting portion 351 protruding inward. In a case where the lid portion 11 (cover member 10) is in the closed state, the engaging knob 162 of the lock portion 16 abuts against the upper surface of the abutting portion 351.

Further, the side wall 35 is provided with the engaging portion 80 at a position corresponding to the abutting portion 351 and on the outer side.

The engaging portion 80 has a square tube-shaped support portion 81 with an open left side. A rectangular notch 83 is formed in the middle portion of the right side wall among the three side walls of the support portion 81. In addition, the engaging protrusion 82 is provided on the right side wall of the support portion 81 so as to straddle both edges of the notch 83 facing each other in the front-rear direction. The engaging protrusion 82 is substantially T-shaped in a plan view and protrudes to the inside of the support portion 81. In a case where the lid portion 11 (cover member 10) is in the closed state, the tip portion of the engaging protrusion 82 is inserted into and engaged with the engaging hole 163 of the engaging knob 162.

It should be noted that a through hole 311 used for screwing with the external bus bar 60 is formed in the middle portion of the terminal 31.

Further, in the housing 50, a support portion 91 is provided to the left of the support mechanism 70 to abut against the flat plate 111 of the lid portion 11 and support the cover member 10 in a case where the cover member 10 is fully open (see FIG. 2). In other words, in a case where the cover member 10 is open by rotating approximately 180 degrees around the rotating shaft 151 from the closed state, the flat plate 111 abuts against the support portion 91 and further rotation is prevented. The support portion 91 has a rectangular plate portion with an upper end abutting against the flat plate 111 of the cover member 10 and a triangular rib provided on the left side surface of such a rectangular plate portion.

The electric connection box 100 of the present embodiment includes the opening maintaining mechanism for maintaining the fully open state where the cover member 10 rotates 180 degrees. The opening maintaining mechanism includes an opening maintaining portion 90 and the notch 131.

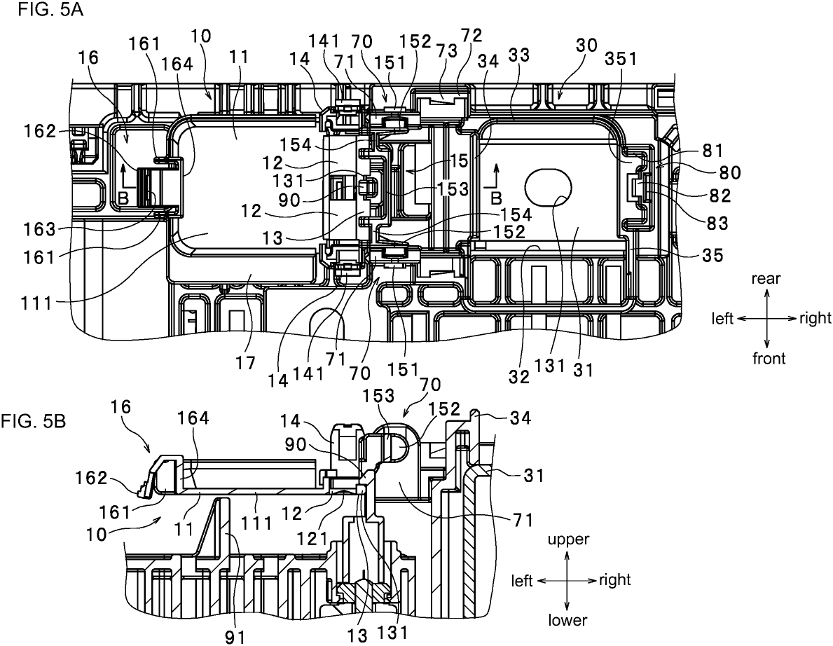

The opening maintaining portion 90 is provided between the support portion 91 and the fitting plate 71. Specifically, the opening maintaining portion 90 is provided at a position corresponding to the position of the notch 131 of the holding portion 13 in a case where the cover member 10 rotates approximately 180 degrees (till fully open state) around the rotating shaft 151 from the closed state (see FIGS. 5B and 7A). The opening maintaining portion 90 has a rod shape long in the up-down direction, and the upper end portion of the opening maintaining portion 90 has a hook shape and protrudes to the side opposite to the connecting portion 30, that is, the left side.

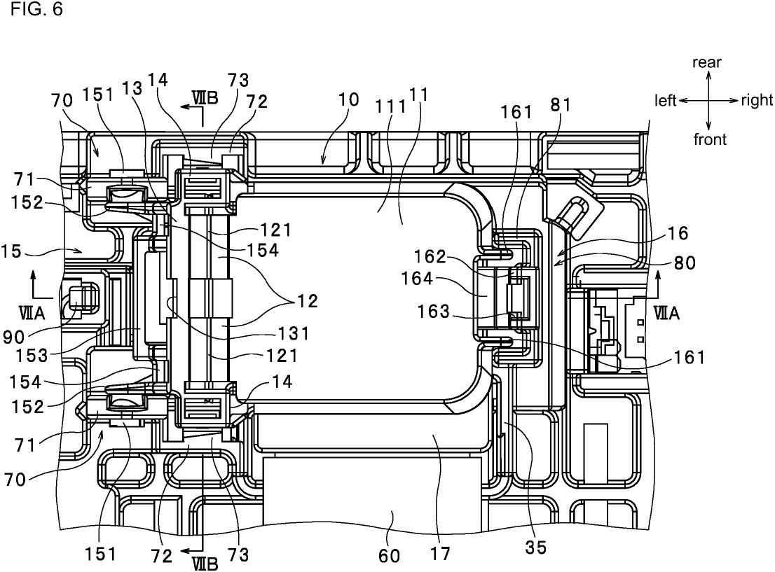

FIGS. 5A and 5B are diagrams illustrating a state where the cover member 10 is fully open in the electric connection box 100 of the present embodiment. FIG. 5A is a plan view, and FIG. 5B is a cross-sectional view taken along line B-B of FIG. 5A. FIG. 6 is a diagram illustrating a case where the cover member 10 is closed in the electric connection box 100 of the present embodiment. FIGS. 7A and 7B are longitudinal sectional views of the cover member 10 of the electric connection box 100 of the present embodiment. FIG. 7A is a longitudinal sectional view taken along line VIIA-VIIA of FIG. 6. FIG. 7B is a longitudinal sectional view taken along line VIIB-VIIB of FIG. 6.

In a case where the cover member 10 is in the fully open state by rotating approximately 180 degrees around the rotating shaft 151, as described above, the flat plate 111 of the lid portion 11 abuts against the support portion 91 and the support portion 91 supports the cover member 10 from below (see FIG. 5B). At this time, the open state of the cover member 10 is maintained by the opening maintaining mechanism.

In other words, when the cover member 10 is in the fully open state, the position of the notch 131 of the holding portion 13 is substantially the same as the position of the opening maintaining portion 90.

Further, the notch 131 is open to the left side in the closed state of the cover member 10 (see FIG. 6) but is open to the right side in the fully open state of the cover member 10 wherein the cover member 10 rotates 180 degrees (see FIG. 5A). Accordingly, the notch 131 engages with the upper end portion of the hook-shaped opening maintaining portion 90 protruding to the left side (see FIG. 5B).

The notch 131 engages with the opening maintaining portion 90 in this manner, and thus the cover member 10 cannot be rotated and cannot be returned to the closed state and the open state is maintained. Accordingly, the electric connection box 100 can be transported with the cover member 10 remaining fully open. Accordingly, in a case where, for example, the external bus bar 60 is screwed to the connecting portion 30 (terminal 31) in the next work process, the operation of opening the cover member 10 can be omitted and workability can be enhanced.

In addition, the notch 131 engages with the opening maintaining portion 90, the cover member 10 is supported from below by the support portion 91, and thus it is possible to prevent rattling from causing noise or damage even if the electric connection box 100 is transported and vibrates with the cover member 10 fully open.

For example, in a case where the work of screwing the external bus bar 60 to the connecting portion 30 (terminal 31) is completed, the worker releases the engagement between the notch 131 and the opening maintaining portion 90 and closes the cover member 10 (lid portion 11) to make the cover member 10 (lid portion 11) the closed state. In this case, each closing maintaining portion 14 of the cover member 10 is disposed inside the corresponding engaged portion 72, and the engaging hook 141 of the closing maintaining portion 14 engages with the engaged protrusion 73 of the engaged portion 72 (see FIG. 7B). In addition, the engaging knob 162 of the lock portion 16 abuts against the upper surface of the abutting portion 351 of the connecting portion 30, and the tip portion of the engaging protrusion 82 is inserted into and engaged with the engaging hole 163 of the engaging knob 162 (see FIG. 7A). In the closed state, the cover member 10 (lid portion 11) covers the connecting portion 30 up to the outside of the terminal 31 and the side walls 33 and 34.

Accordingly, the closed state of the cover member 10 (lid portion 11) can be maintained, and it is possible to prevent the cover member 10 (lid portion 11) from opening. Accordingly, it is possible to forestall an electric shock accident attributable to the connecting portion 30 being exposed and touched by a person.

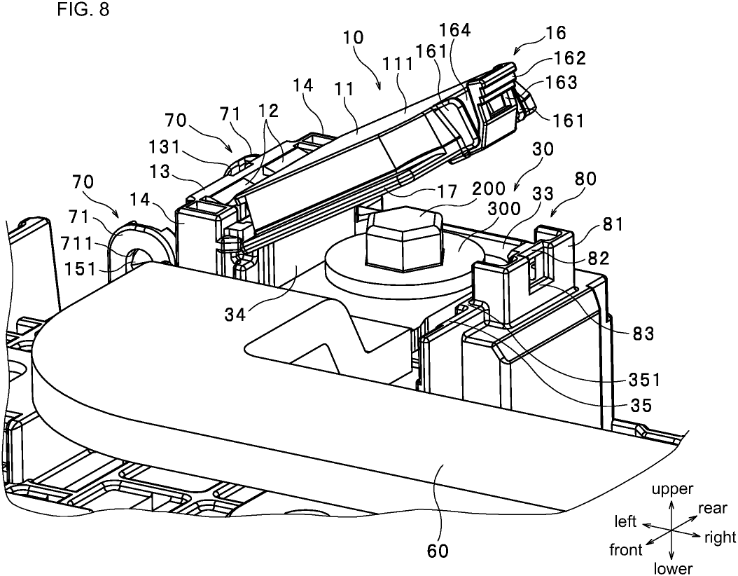

For some reason, the external bus bar 60 may be removed during the subsequent use of the electric connection box 100. In this case, the worker has only to open the lid portion 11 with the cover member 10 remaining closed. FIG. 8 is a diagram illustrating a case where only the lid portion 11 is open when the cover member 10 is closed in the electric connection box 100 of the present embodiment.

The worker pushes the engaging knob 162 of the lock portion 16 to the left side to release the engagement between the engaging hole 163 of the engaging knob 162 and the engaging protrusion 82. When the lid portion 11 is opened after the releasing the engagement, the lid portion 11 rotates about the hinge 12 as a rotation axis and is opened (see FIG. 8). At this time, the engaging hook 141 of the closing maintaining portion 14 continues to engage with the engaged protrusion 73 of the engaged portion 72 and the cover member 10 remains closed.

After removing the external bus bar 60 by loosening a bolt 200 and a washer 300, the worker closes the lid portion 11 by pushing down the upper surface of the lid portion 11 (flat plate 111). At this time, the engaging knob 162 of the lock portion 16 abuts against the upper surface of the abutting portion 351 of the connecting portion 30, and the tip portion of the engaging protrusion 82 is inserted into and engaged with the engaging hole 163 of the engaging knob 162 again.

In this manner, in the electric connection box 100 of the present embodiment, when removing the external bus bar 60, the cover member 10 itself does not have to be opened and only the lid portion 11 needs to be opened, and thus workability can be enhanced.

Meanwhile, a case is conceivable where the worker forgets to close the lid portion 11 after the work of removing the external bus bar 60. In this case, the connecting portion 30 (terminal 31) is exposed, and thus an electric shock accident may occur by a person touching the terminal 31.

The electric connection box 100 of the present embodiment is capable of coping with this. As described above, in a case where the lid portion 11 is open with the cover member 10 remaining closed, the restoring force of the hinge 12 that is generated by the bending of hinge 12 acts on the lid portion 11, the lid portion 11 is biased such that the terminal 31 is shielded, and thus the lid portion 11 covers and does not expose the terminal 31. Accordingly, the terminal 31 can be prevented from being exposed even in a case where the worker forgets to close the lid portion 11.

In addition, in the electric connection box 100 of the present embodiment, the lid portion 11 is provided with the flange portion 17, and thus it is possible to prevent as much as possible a connecting portion with peeled insulation coating of the external bus bar 60 from being exposed to the outside.

Further, in the electric connection box 100 of the present embodiment, the two hinges 12 hold the lid portion 11. Accordingly, even in a case where one of the hinges 12 is broken in the groove 121 due to fatigue attributable to repeated opening and closing of the lid portion 11, it is possible to continue to hold the lid portion 11 by the other hinge 12.

Described above as an example is a case where the opening maintaining mechanism maintains the cover member 10 in the fully open state with a rotation angle of 180 degrees. However, the present disclosure is not limited thereto. By increasing the height of the opening maintaining portion 90, it is also possible to maintain the cover member 10 in an open state with a rotation angle of less than 180 degrees.

The embodiment disclosed this time is an exemplification in every respect and should be considered not restrictive. The scope of the present disclosure is defined not by the meaning described above but by the scope of the claims and is intended to include every modification within the meaning and scope equivalent to the scope of the claims.

It is to be noted that, as used herein and in the appended claims, the singular forms “a”, “an”, and “the” include plural referents unless the context clearly dictates otherwise.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

What is claimed is:

1. A vehicular electric connection box comprising:
a housing having a connecting portion including a terminal connected to an external conductive tool; and
a cover member opening and closing the connecting portion,
wherein the cover member has a lid portion exposing or shielding the terminal with the cover member closed.

2. The electric connection box according to claim 1, wherein
the cover member is provided with a hinge holding the lid portion, and
the hinge biases the lid portion so as to shield the terminal.

3. The electric connection box according to claim 2, wherein
the hinge has a rectangular plate shape and is connected to the lid portion on a side of one long side, and
a groove is formed in one main surface of the hinge and a thickness of the hinge decreases toward a middle portion in a width direction.

4. The electric connection box according to claim 3, wherein the hinge is two in number and the two hinges are arranged side by side in a length direction at an interval.

5. The electric connection box according to claim 2, further comprising an opening maintaining mechanism maintaining an open state of the cover member.

6. The electric connection box according to claim 5, wherein the opening maintaining mechanism includes:
a notch formed in a holding portion holding the hinge from a vicinity of the other long side of the hinge; and
an opening maintaining portion provided in the housing to engage with the notch and maintain the open state in a case where the cover member is in the open state.
